(19) United States
(12) Patent Application Publication
(10) Pub. No.: US 2019/0057347 A1
(43) Pub. Date: Feb. 21, 2019

(54) System and method for delivery order processing

(71) Applicant: IPDEV Co., Chicago, IL (US)

(72) Inventors: James Vitek, Ann Arbor, MI (US); Jeremiah A. Sheehy, JR., Chicago, IL (US)

(21) Appl. No.: 15/998,684

(22) Filed: Aug. 15, 2018

Related U.S. Application Data
(60) Provisional application No. 62/545,667, filed on Aug. 15, 2017.

(51) Int. Cl. G06Q 10/08; G06Q 20/20; G06Q 10/06

(52) U.S. Cl. CPC G06Q 10/0834; G06Q 10/06311; G06Q 20/20

(57) ABSTRACT

A method for determining dispatch assignments of delivery orders by a point of sale (POS) device of a storefront is described. A plurality of delivery orders for the storefront are received by the POS device. The POS device determines an estimate of an order efficiency value for the storefront based on the plurality of delivery orders and a delivery employee pool corresponding to the storefront. The POS device automatically determines a dispatch assignment of one or more delivery orders for the storefront to one of i) an employee of the delivery employee pool, or ii) a contractor of an independent contractor pool, based on whether the order efficiency value meets a predetermined service threshold.

### CROSS-REFERENCE TO RELATED APPLICATION

This disclosure claims the benefit of U.S. Provisional Patent Application No. 62/545,667, entitled “System and Method for Delivery Order Processing” and filed on Aug. 15, 2017, the disclosure of which is incorporated herein by reference in its entirety.

### FIELD OF TECHNOLOGY

The present disclosure relates in general to a system and method for delivery order processing.

### BACKGROUND

Vendors of food and goods often provide a delivery service to bring ordered products to customers at their home, place of business, job site, or other location. Some vendors receive a substantial portion of revenue from delivery orders and experience periods of very high demand. For example, a pizza restaurant may receive a high number of orders via phone calls or an online ordering system during a dinner time period from 5:00 PM to 8:00 PM on a Friday. During these high demand periods, vendors strive to fulfill each delivery order efficiently so that they can process as many orders as practicable. To complement kitchen staff and/or order packers who prepare an order for delivery, vendors often have dedicated delivery employees whose primary job function is to transport a prepared order (e.g., pizza, beverages, groceries, or other goods) from the vendor's storefront or preparation facility to the customer's desired location.

When an order is placed for delivery, the vendor frequently provides a “promise time” to the customer, which indicates an estimated time of delivery for the order. The promise time is based on current numbers of delivery employees or kitchen staff, a current number of orders being processed by the vendor, delivery addresses for the orders, or other suitable factors. For example, when a high number of orders are being prepared or are waiting to be delivered but only a low number of delivery employees are available (e.g., 20 orders for 2 delivery employees), then a higher promise time may be indicated to customers placing new orders (e.g., 30 minutes instead of 20 minutes). In many scenarios of high demand periods, additional delivery employees would improve the likelihood of meeting the promise times of multiple orders.

Efficient order delivery during high demand periods often requires multiple orders to be grouped together for a single trip by a delivery driver. Some employees can be trained to effectively group orders and assign the group to a delivery driver. However, as more inputs are made available for consideration when selecting a group of orders, employees may suffer from “information overload” that reduces their efficiency or does not fully consider the available inputs.

### BRIEF DESCRIPTION OF THE DRAWINGS

FIG. 1 is a block diagram of a distributed or cloud computing system, according to an embodiment.

FIG. 2 is a block diagram of an internal configuration of a computing device, such as a computing device of the computing system as shown in FIG. 1, according to an embodiment.

FIG. 3 is a block diagram of an example storefront order handling system, according to an embodiment.

FIG. 4 is a diagram of an example graphical user interface for a dispatch device of the storefront order handling system of FIG. 3, according to an embodiment.

FIG. 5 is a diagram of an example graphical user interface for a delivery device of the storefront order handling system of FIG. 3 and illustrates a summary of a dispatch assignment, according to an embodiment.

FIG. 6 is a diagram of an example graphical user interface for the delivery device and illustrates a summary of a delivery order, according to an embodiment.

FIG. 7 is a diagram of an example graphical user interface for the delivery device and illustrates a delivery order completion, according to an embodiment.

FIG. 8 is a flow diagram of an example method of determining dispatch assignments of delivery orders by a point of sale device of a storefront, according to an embodiment.

FIG. 9 is a flow diagram of an example method of grouping delivery orders into a dispatch assignment by a point of sale device of a storefront, according to an embodiment.

### DETAILED DESCRIPTION

In the present disclosure, various embodiments of systems and methods for determining dispatch assignments of delivery orders are described. In general, each dispatch assignment includes one, two, or more orders to be delivered to respective customers from a storefront or other order preparation facility. To improve performance and efficiency of deliveries and thus improve profits for the storefront, a dispatch device monitors an order efficiency value for the storefront, for example, a ratio of pending orders to a number of delivery drivers available to deliver the orders. When the order efficiency value meets a predetermined threshold (e.g., indicating that customer satisfaction may be reduced), the dispatch device provides an indication that additional delivery drivers should be called in. In some scenarios, the dispatch device automatically calls in additional drivers. In still other scenarios, the dispatch device contacts independent contractors to handle some of the orders. In this way, the storefront can more easily provide desired levels of service during peak order periods while keeping overhead costs of employees to acceptable levels.

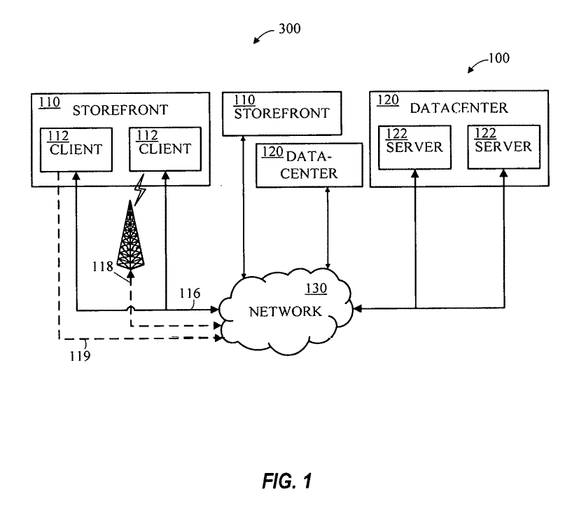

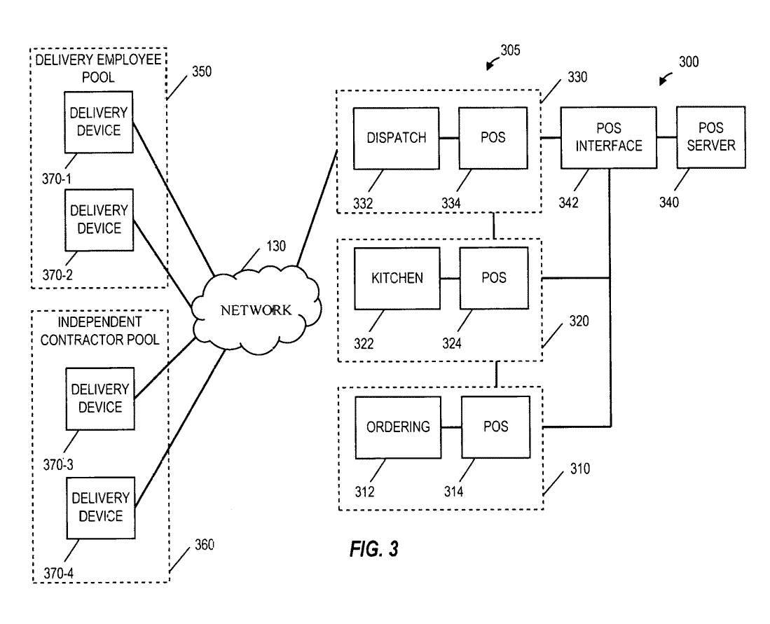

To describe some embodiments in greater detail, reference is first made to examples of hardware structures and interconnections usable in various embodiments of the present disclosure. FIG. 1 is a block diagram of a computing system 100, for example, a distributed or cloud computing system. Use of the phrase “cloud computing system” herein is a proxy for any suitable form of a distributed computing system, and this phrase is used simply for ease of reference. Cloud computing system 100 is configured for operation as, or with, one or more storefront order handling systems 300 (FIG. 3). In some embodiments or scenarios, a storefront order handling system 300 operates as a standalone system, without the cloud computing system.

The cloud computing system 100 includes one or more storefronts 110. A storefront 110 includes one or more client devices 112. Example embodiments of the client device 112 include a mobile phone, a tablet computer, a laptop computer, a notebook computer, a desktop computer, and the like. Although only two storefronts 110 are shown, the cloud computing system 100 may have a different number of storefronts 110, for example, hundreds or thousands of storefronts, each with one, two, or more client devices 112.

In the embodiments described herein, the storefront 110 is a restaurant storefront that provides a delivery service for prepared foods, for example, pizza, sandwiches, etc. In other embodiments, the storefront 110 is a preparation facility for a vendor that provides a delivery service for orders. In these embodiments, for example, a delivery order includes a grocery order, clothing order, or other suitable order for goods that are packaged or grouped and then delivered to a customer's desired location (e.g., home, office, job site, etc.).

The cloud computing system 100 includes one or more datacenters 120, each having one or more servers 122. Each datacenter 120 may represent a facility in a different geographic location where servers are located, for example. Each of servers 122 can be in the form of a computing system including multiple computing devices (e.g., a cluster), or in the form of a single computing device, for example, a desktop computer, a server computer, a virtual machine and the like. The datacenter 120 and servers 122 are examples only, and the cloud computing system 100 may have a different number of datacenters and servers or may have a different configuration of datacenters and servers. For example, there may be tens of datacenters and each datacenter may have hundreds or any number of servers.

The client devices 112 and servers 122 are configured to communicate via network 130. In some embodiments, multiple client devices 112 connect to the network 130 via a common communication link 116 (e.g., a shared broadband link). In some embodiments, the client devices 112 use different communication links, e.g. a wireless communication link 118 (e.g., provided by a wireless access point or cellular tower) or a wired communication link 119 (e.g., provided by a wired network switch or router). Any combination of common or different communication links may be present, and any combination of wired and wireless communication links may be present as well. Network 130 can be, for example, the Internet. Network 130 can also be or include a local area network (LAN), wide area network (WAN), virtual private network (VPN), or any other means of transferring data between any of client devices 112 and servers 122. Network 130, datacenter 120 and/or blocks not shown may include network hardware such as routers, switches, load balancers and/or other network devices.

In various embodiments, the storefront 110 corresponds to a restaurant operator, franchisee, store manager, or other suitable operator of a point of sale or point of service. In various embodiments, the datacenter 120 corresponds to a restaurant central office, franchisor, regional manager, or other suitable centralized point of management of one or more storefronts 110.

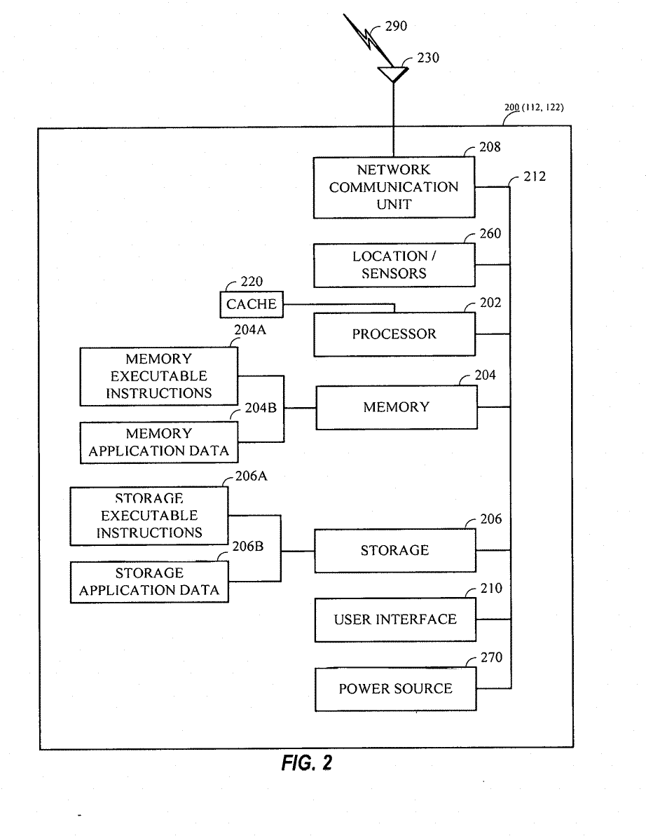

FIG. 2 is a block diagram of an example internal configuration of a computing device 200, such as a client 112 or server 122 of the computing system 100 as shown in FIG. 1, including an infrastructure control server of a computing system. The client devices 112 or servers 122 are implemented as computing systems including multiple computing units, or in the form of a single computing unit, for example, a mobile phone, a tablet computer, a laptop computer, a notebook computer, a desktop computer, a server computer and the like.

The computing device 200 can include a number of components, as illustrated in FIG. 2. Processor 202 can be a central processing unit, such as a microprocessor, and can include single or multiple processors, each having single or multiple processing cores. Alternatively, processor 202 can include another type of device, or multiple devices, capable of manipulating or processing information now-existing or hereafter developed. When multiple processing devices are present, they may be interconnected in any manner, including hardwired or networked, including wirelessly networked. Thus, the operations of processor 202 can be distributed across multiple machines that can be coupled directly or across a local area or other network. The processor 202 can be a general purpose processor or a special purpose processor.

Random Access Memory (RAM) 204 can be any suitable non-permanent storage device that is used as memory. RAM 204 can include executable instructions and data for access by processor 202. RAM 204 typically comprises one or more DRAM modules such as DDR SDRAM. Alternatively, RAM 204 can include another type of device, or multiple devices, capable of storing data for processing by processor 202 now-existing or hereafter developed. Processor 202 can access and manipulate data in RAM 204 via bus 212. The processor 202 may utilize a cache 220 as a form of localized fast memory for operating on data and instructions.

Storage 206 can be in the form of read only memory (ROM), a disk drive, a solid state drive, flash memory, Phase-Change Memory (PCM), or any form of non-volatile memory designed to maintain data for some duration of time, and preferably in the event of a power loss. Storage 206 can include executable instructions 206A and application files/data 206B along with other data. The executable instructions 206A can include, for example, an operating system and one or more application programs for loading in whole or part into RAM 204 (with RAM-based executable instructions 204A and application files/data 204B) and to be executed by processor 202. The executable instructions 206A may be organized into programmable modules or algorithms, functional programs, codes, and code segments designed to perform various functions described herein. The operating system can be, for example, a Microsoft Windows®, Mac OS X®, or Linux® operating system, or can be an operating system for a small device, such as a smart phone or tablet device (e.g., Android or iOS), or a large device, such as a mainframe computer. The application program can include, for example, a web browser, web server and/or database server. In an embodiment, the application programs include one or more of a delivery app (described below), dispatch app (described below), a mapping app (e.g., Google Maps), phone app, instant messaging app, text messaging app, or other suitable apps. Application files 206B can, for example, include user files, database catalogs and configuration information. In an embodiment, storage 206 includes instructions to perform the discovery techniques described herein. Storage 206 may comprise one or multiple devices and may utilize one or more types of storage, such as solid state or magnetic.

The computing device 200 can also include one or more input/output devices, such as a network communication unit 208 and interface 230 that may have a wired communication component or a wireless communications component 290, which can be coupled to processor 202 via bus 212. The network communication unit 208 can utilize any of a variety of standardized network protocols, such as Ethernet, TCP/IP, or the like to effect communications between devices. The interface 230 can comprise one or more transceiver(s) that utilize the Ethernet, power line communication (PLC), WiFi, infrared, GPRS/GSM, CDMA, etc.

A user interface 210 can include a display, positional input device (such as a mouse, touchpad, touchscreen, or the like), keyboard, or other forms of user input and output devices. The user interface 210 can be coupled to the processor 202 via the bus 212. Other output devices that permit a user to program or otherwise use the client or server can be provided in addition to or as an alternative to display 210. When the output device is or includes a display, the display can be implemented in various ways, including by a liquid crystal display (LCD) or a cathode-ray tube (CRT) or light emitting diode (LED) display, such as an OLED display.

Other embodiments of the internal configuration or architecture of clients and servers 200 are also possible. For example, servers may omit display 210. RAM 204 or storage 206 can be distributed across multiple machines such as network-based memory or memory in multiple machines performing the operations of clients or servers. Although depicted here as a single bus, bus 212 can be composed of multiple buses, that may be connected to each other through various bridges, controllers, and/or adapters. Computing devices 200 may contain any number of sensors and detectors that monitor the computing device 200 itself or the environment around the computing device 200, or it may contain a location identification unit 260, such as a GPS or other type of location device. The computing device 200 may also contain a power source 270, such as a battery, so that the unit can operate in a self-contained manner. These may communicate with the processor 202 via the bus 212.

FIG. 3 is a block diagram of an example storefront order handling system 300, according to an embodiment. The storefront order handling system 300 includes a storefront 305 with one or more client devices, which generally correspond to the storefront 110 and client devices 112. More specifically, the storefront 305 includes an order entry device 310, an order display device 320, and a dispatch device 330 as client devices. In other embodiments, the order entry device 310 and/or the order display device 320 are omitted. For example, for a consumer goods vendor storefront that does not have a kitchen, the dispatch device 330 directly receives orders (e.g., via a user interface or other communication interface), in an embodiment.

The order entry device 310 is configured to receive orders (e.g., from an online ordering system, not shown) and/or for manual entry of an order by an employee of the storefront 305. In various embodiments, the order entry device 310 includes an ordering component 312 and/or a point of sale (POS) component 314. The ordering component 312 provides a user interface (not shown) configured for entry of a delivery order, for example, via a touch-screen display, a display and keypad, or other suitable interface. In some embodiments, the order entry device 310 is a commercial POS device and the ordering component 312 is omitted or combined with the POS device. In other embodiments, the order entry device 310 is a tablet computer, smartphone, or other suitable computing device configured to provide ordering functionality. The order entry device 310 provides orders to the order display device 320 and/or the dispatch device 330, in various embodiments.

Based on received and/or entered information, the order entry device 310 creates an entry for a delivery order with one or more fields, for example, a promised fulfillment time (“promise time”), an estimated delivery time, a delivery address or location, an order status (e.g., ready for delivery, in the oven, being prepared, etc.), order information (e.g., pizza type and toppings, products ordered), customer information (name, phone number, email address, preferred contact method), payment information (payment type, paid/unpaid status, billing address, credit card information, etc.). In some embodiments, the order entry device 310 obtains information for some of the fields of the entry from a POS server 340, optionally, via a POS interface 342. In some embodiments, the POS server 340 generally corresponds to the server 122 and is configured with software for remote management, for example, Next Generation Point Of Sale software (NGPOS; AMC Enterprises Pty. Ltd., Moorabbin, VIC, Australia), Susoft (Susoft AS, Kleppestø, Norway), or other suitable management software. In some embodiments, the POS server 340 provides one or more of pricing information for order deals (e.g., a discount given when a combination of products is ordered together) or an online ordering system (e.g., providing orders to the order entry device 310). In an embodiment, the POS server 340 stores configuration information for one or more of the order entry device 310, the order display device 320, the dispatch device 330, and delivery devices (352, 362, described below).

The order display device 320 is configured to provide order information to kitchen staff and/or order packers who prepare an order for delivery. In various embodiments, the order display device 320 includes a kitchen component 322 and/or a POS component 324. The kitchen component 322 provides a display and/or user interface that indicates how to prepare the order. For example, the kitchen component 322 displays information indicating a pizza type (thin crust, pan pizza), pizza toppings, special instructions from the customer, or related information. In an embodiment, the kitchen component 322 provides a user interface that allows the kitchen staff to update an order based on its preparation status, for example, to indicate that the order has been prepared, placed in an oven, and packed in a box for delivery. In some embodiments, the order display device 320 updates the order to indicate the “cook time” or preparation time as the order is prepared for delivery. In some embodiments, the order display device 320 is a commercial POS device and the kitchen component 322 is omitted or combined with the POS device. In other embodiments, the order display device 320 is a tablet computer, smartphone, or other suitable display device configured to provide order information.

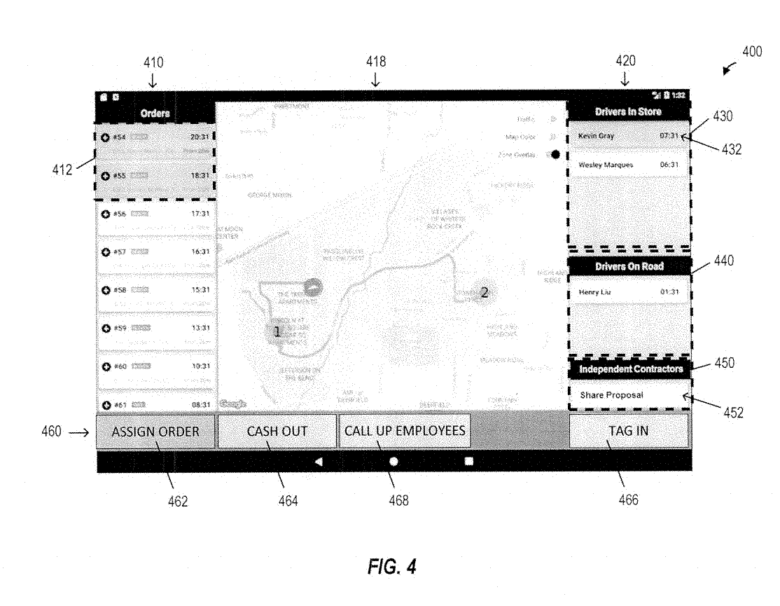

In various embodiments, the dispatch device 330 includes a dispatch component 332 and/or a point of sale (POS) component 334. The dispatch component 332 provides a user interface (400, FIG. 4) configured for display and/or management of a plurality of delivery orders handled by the storefront 305, for example, via a touch-screen display, a display and keypad, or other suitable interface, in some embodiments. In an embodiment, the dispatch device 310 is a commercial POS device and the dispatch component 332 is omitted or combined with the POS device. In other embodiments, the dispatch device 330 is a tablet computer, smartphone, or other suitable computing device configured to provide dispatch functionality. In an embodiment, the dispatch component 332 is configured to communicate with the POS component 334 (e.g., a commercial POS device) to obtain the delivery orders and/or provide updates for delivery status.

The dispatch device 330 is configured to automatically determine dispatch assignments of delivery orders. As used herein, a dispatch assignment is an assignment of one or more delivery orders for the storefront 305 to an order handler (e.g., a delivery driver, self-driving vehicle configured for performing deliveries, autonomous drone configured for performing deliveries). For example, a dispatch assignment provides information to direct a delivery driver to pick up a particular order (or orders) and deliver to the appropriate address, receive payment if needed, etc. In various embodiments, the dispatch device 330 provides a user interface that displays the dispatch assignments, allows an order expediter to select and display a dispatch assignment, manually modify the dispatch assignment, or manually create a dispatch assignment. An order expediter is an employee who, for example, carries orders to the delivery driver, is responsive to customer follow-ups (e.g., phone calls about their order), communicates with delivery drivers, or other tasks. In some scenarios, the dispatch device 330 provides a dispatch assignment proposal (e.g., an unconfirmed dispatch assignment) to the order expediter who later confirms the assignment (e.g., causing the assignment to be provided to a delivery driver), modifies the assignment before confirmation, or discards the proposal. In this way, the order expediter can adjust the sequence of deliveries, for example, to provide faster service for customers who have called to inquire about their order. In some embodiments, the dispatch device 330 determines dispatch assignments of orders that are i) ready for delivery, ii) currently being prepared (e.g., in an oven or on a make line in a kitchen), and/or iii) have been entered but not yet started preparation.

The dispatch device 330 provides a user interface that identifies delivery drivers and their respective location statuses, in various embodiments. In an embodiment, the delivery drivers include employees of a delivery employee pool 350 and contractors of an independent contractor pool 360. The delivery employee pool 350 includes drivers that are full-time or part-time employees of the storefront 305 and thus generally have a predetermined “clock in” and “clock out” time for a given work shift. The independent contractor pool 360 includes drivers that are offered dispatch assignments and can choose whether to accept the dispatch assignment. In some embodiments, the independent contractor pool 360 includes employees for a different storefront 305 (e.g., a different franchise location). While the drivers of the delivery employee pool 350 are generally paid hourly, regardless of how many deliveries they perform, drivers of the independent contractor pool 360 are paid based on the number of orders they deliver. In some embodiments, drivers of the independent contractor pool 360 are paid weekly, daily, or another suitable interval. In other embodiments, drivers of the independent contractor pool 360 are paid within minutes of performing a delivery, after an end of business day for the storefront 305, or other suitable time. In an embodiment, the dispatch device 330 triggers payment to the contractor via an electronic bank transfer, cryptocurrency transfer, or online payment systems (e.g., PayPal, Venmo, Google Wallet).

In various embodiments, the location status of a delivery driver corresponds to one or more of a current location of the driver (e.g., at the storefront 305, on the road or away from the storefront 305, or GPS coordinates of the current location), an availability status of the driver (available for delivery orders, out delivering a delivery order, unavailable for deliveries, on a break, etc.), and relevant timing information. The timing information includes, for example, one or more of an estimated time of arrival (ETA) to a customer's location, an estimated time of arrival to the storefront 305 (e.g., an availability ETA or estimated time of availability), an amount of idle time at the storefront 305 (e.g., time spent waiting for orders to be prepared for delivery), or other suitable timing information. In various embodiments or scenarios, the timing information is displayed as a remaining time (e.g., 3 minutes until delivery) or a late time (e.g., 2 minutes after a promised time for an order).

The dispatch device 330 shows orders in various stages of preparation, in an embodiment. For example, the dispatch device 330 displays an order status as it is being entered (by the order entry device 310), being prepared, in the oven, ready for delivery, out for delivery, and delivered. The dispatch device 330 also includes a user interface for communication with the delivery driver, for example, a phone or short messaging service (SMS) interface, in an embodiment.

In embodiments where the order handlers are delivery drivers (employees or contractors), the delivery drivers utilize a delivery device, for example, delivery devices 370, for communication with the dispatch device 330 and receiving dispatch assignments. In some embodiments, the delivery device 370 is configured to display one or more of order information (e.g., order numbers), special instructions for delivery, customer contact information, a delivery address and/or delivery zone indicator (e.g., grid coordinates), GPS coordinates of the delivery address, payment information (e.g., paid or unpaid status, payment type), driving directions, and related information for handling delivery orders.

The delivery devices 370 generally correspond to the computing device 200 and may be implemented as smartphones, tablets, or other suitable electronic devices. In the embodiment shown in FIG. 3, the employees of the delivery employee pool 350 and the contractors of the independent contractor pool 360 utilize a generally same delivery device 370. In this embodiment, the delivery devices 370 are configured with a same delivery app (e.g., software that configures a smartphone or tablet), but may have different hardware configurations, for example, where delivery drivers use their personal smartphone as the delivery device 370.

In some embodiments, the delivery devices 370 are configured with different delivery apps for employees and contractors. For example, the delivery device 370 is configured to allow an employee to enter an amount of money received as a tip from a customer, while the independent contractor is not required to enter the tip. As another example, the delivery device 370 is configured to allow a contractor to review available dispatch assignment proposals, accept a dispatch assignment proposal, and facilitate payments from the storefront 305 (e.g., by providing account information for an electronic bank transfer, cryptocurrency transfer, or online payment system).

The delivery app of the delivery device 370 interacts with the operating system and/or other apps on the delivery device 370, in some embodiments. For example, to provide driving directions, the delivery app of the delivery device 370 provides an address or GPS coordinates to a mapping app (e.g., Google Maps) for determination of the driving directions. As another example, the delivery app provides contact information to a phone app, instant messaging app, or text messaging app for communication with the customer or the storefront 305 (e.g., the order expediter).

The delivery device 370 provides updates to the dispatch device 330 that include one or more of its current location, ETA to the storefront 305, ETA to the delivery location, and other suitable information. The delivery device 370 sends information to and receives information from the dispatch device 330 via one or more of the network 130 (e.g., through a cellular service), a WiFi network, Bluetooth, Near Field Communication, or other suitable communication link. In some embodiments, the delivery device 370 determines a location status of the delivery device 370 based on geofencing for the storefront 305 (e.g., GPS coordinates of the delivery device 370 are within a predetermined geographical area), association with a WiFi network of the storefront 305, detection or pairing over Bluetooth, or other suitable technique. For example, when a delivery driver arrives at the storefront 305, the delivery device 370 associates with the WiFi network and communicates with the dispatch device 330 to indicate that the delivery driver is available to deliver a new order. In an embodiment, the delivery device 370 of an employee of the delivery employee pool 350 automatically clocks in the employee based on the location status.

FIG. 4 is a diagram of an example graphical user interface (GUI) 400 for the dispatch device 330 of the storefront order handling system 300 of FIG. 3, according to an embodiment. The GUI 400 is provided by a dispatch app of the dispatch device 330 that configures a tablet, smartphone, touch-screen display, or other suitable device. The GUI 400 generally provides a management console for the order expediter to check status of delivery orders, view, modify, or confirm dispatch assignments, view driver location status and delivery routes, and other suitable tasks.

In the embodiment shown in FIG. 4, the GUI 400 includes an order listing 410, a map 418, an order handler listing 420, and a menu bar 460. The order listing 410 includes information for a plurality of delivery orders for the storefront 305. In an embodiment, the order listing 410 is provided with the delivery orders arranged chronologically (e.g., oldest orders are listed first), prioritized by customer, delivery address, or a combination thereof. In the embodiment shown in FIG. 4, the delivery orders are displayed with an order number, delivery address, promise time, order age, and current status: “Ready” for delivery (Orders 45, 55, 56, 57, 58), “In Oven” while an order (e.g., pizza) is being cooked (Orders 59, 60), and “Prep” while an order is being prepared for the oven (Order 61).

The map 418 shows routes for a dispatch assignment, current locations of order handlers, and other suitable information. In some embodiments, the map 418 is configured with one or more overlays which can be toggled on or off, for example, to display traffic, delivery zones (e.g., a grid system or other predetermined zones), map colors, employee locations, and/or contractor locations. In an embodiment, the dispatch app of the dispatch device 330 obtains map information from a mapping app of the dispatch device 330 or another third party service.

The order handler listing 420 includes location statuses for order handlers (e.g., a delivery driver, self-driving vehicle, autonomous drone) and other suitable information. In some embodiments, the order handler listing 420 indicates whether an order handler is an employee of the delivery employee pool 350 or a contractor of the independent contractor pool 360. In the embodiment shown in FIG. 4, the order handler listing 420 includes an identifier (e.g., driver name) along with the location status of the order handler. In some embodiments, the order handlers are arranged in order based on location status. For example, as shown in FIG. 4, delivery drivers are separated into a first group 430 of drivers in the store waiting for a dispatch assignment, a second group 440 of drivers on the road making deliveries, and a third group 450 of independent contractors. Drivers in the first group 430 are shown with a time indicator of how long the driver has been waiting in the store for a dispatch assignment. Drivers in the second group 440 are shown with an ETA to the storefront 305 for the driver.

The GUI 400 is configured to provide dispatch assignments or dispatch assignment proposals to contractors of the independent contractor pool 360. As used herein, a dispatch assignment proposal is a dispatch assignment that has not yet been confirmed. In some scenarios, the dispatch assignment proposal is provided to a contractor who can then accept or decline the proposal, for example, via the user interface of the delivery device 370. In the embodiment shown in FIG. 4, the GUI 400 includes a button 452 to share a dispatch assignment proposal. In an embodiment, the button 452 causes the dispatch device 330 to send a dispatch assignment proposal to an individual contractor of the independent contractor pool 360. In this embodiment, the delivery device 370 provides an opportunity for the contractor to accept the proposal, for example, within a predetermined time period of 5 second, 10 seconds, or other suitable period, after which the proposal is rescinded so that the expediter can provide the opportunity to another contractor. In an embodiment, the dispatch device 330 selects or suggests which contractor should receive the proposal, for example, based on customer satisfaction rating, past performance, proximity to the storefront 305, or other suitable criteria.

In other embodiments, the button 452 causes the dispatch device 330 to send a dispatch assignment proposal to multiple contractors via respective delivery devices 370. In an embodiment, the delivery devices 370 provide respective opportunities to the multiple contractors and a contractor is selected from among those contractors that accept the proposal. For example, the dispatch device 330 selects or suggests which contractor should receive the proposal based on how quickly the contractor responded, their customer satisfaction rating, past performance, proximity to the storefront 305, or other suitable criteria.

A dispatch assignment proposal shown in FIG. 4 includes selected delivery orders 412 (Orders 54 and 55), to be assigned to a selected order handler (driver 432, “Kevin Gray”), with a proposed driving route in the map 418. In some embodiments, the dispatch device 330 automatically determines the dispatch assignment and sends the dispatch assignment to the dispatch device 370 corresponding to the selected order handler. In the embodiment shown in FIG. 4, the menu bar 460 includes a button 462 (“Assign Order”) that allows the expediter to confirm the dispatch assignment or to create a dispatch assignment from selected delivery orders and a selected driver. Upon confirmation, the dispatch device 330 transmits a dispatch assignment to the corresponding employee or contractor.

The menu bar 460 includes one or more buttons for functions initiated by the expediter. In the embodiment shown in FIG. 4, the menu bar 460 includes the button 462, a button 464 (“Cash Out”), a button 466 (“Tag In”), and a button 468 (“Call Up Employees”). Although reference is made herein to a user interface “button,” other user interface elements or interactions (e.g., swipe, gesture, voice activation, click, tap) are used, in other embodiments. As discussed above, the button 462 allows the expediter to confirm a dispatch assignment. The button 464 allows the expediter to access a cash drawer to provide cash to a delivery driver for making change on payment of a delivery. For example, in response to pressing the button 464, the dispatch device 330 communicates with a cash drawer (not shown) to release the cash drawer. In an embodiment, the expediter presses the button 464 to obtain cash to pay a contractor that has completed a delivery. The button 466 allows the expediter to manually check in a delivery driver who has arrived at the storefront 305 to indicate that the delivery driver is available to deliver a new order. For example, in response to pressing the button 466, the dispatch device 330 provides a prompt to the expediter to enter an employee identification number, scan an employee bar code, or identify the delivery driver in another suitable manner. The button 468 allows the expediter to send a request to other employees who are not currently working. For example, in response to pressing the button 468, the dispatch device 330 sends a text message, email, an app notification in the delivery app, or other suitable communication to an employee with a request to start working.

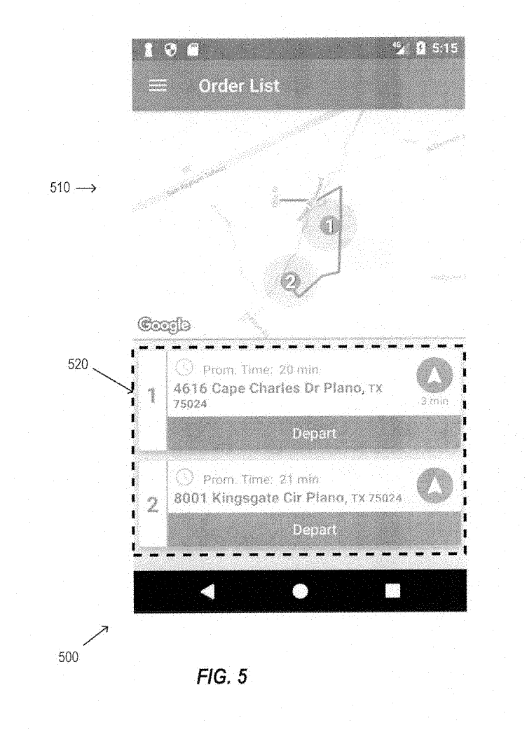

FIG. 5 is a diagram of an example GUI 500 for the delivery device 370 of the storefront order handling system 300 of FIG. 3 and illustrates a summary of a dispatch assignment, according to an embodiment. The GUI 500 is provided by the delivery device 370 via the delivery app, in an embodiment. In other embodiments, the delivery device 370 uses a web browser and a dynamic web page (e.g., dynamic hypertext markup language, asynchronous Javascript and extensible markup language). The dynamic web page is hosted by the dispatch device 330, the POS server 340, the server 122, or other suitable location, in various embodiments.

The delivery device 370 displays the summary of FIG. 5, for example, when a dispatch assignment has been initially received from the dispatch device 330. The GUI 500 includes a map 510 and an order list 520. The map 510 shows a proposed route for delivering the orders in the order list 520. In an embodiment, the map 510 includes one or more overlays which can be toggled on or off, for example, to display traffic, delivery zones, etc. The order list 520 provides a summary of delivery orders of the dispatch assignment. In the embodiment shown in FIG. 5, the order list 520 includes respective delivery addresses, promise times, and ETAs to the delivery addresses. In some embodiments, the delivery device 370 is configured to allow the delivery driver to choose which delivery order of the order list 520 is handled first, for example, by pressing the corresponding “Depart” button. Upon selection of one of the orders, the delivery device 370 provides a summary of the selected delivery order.

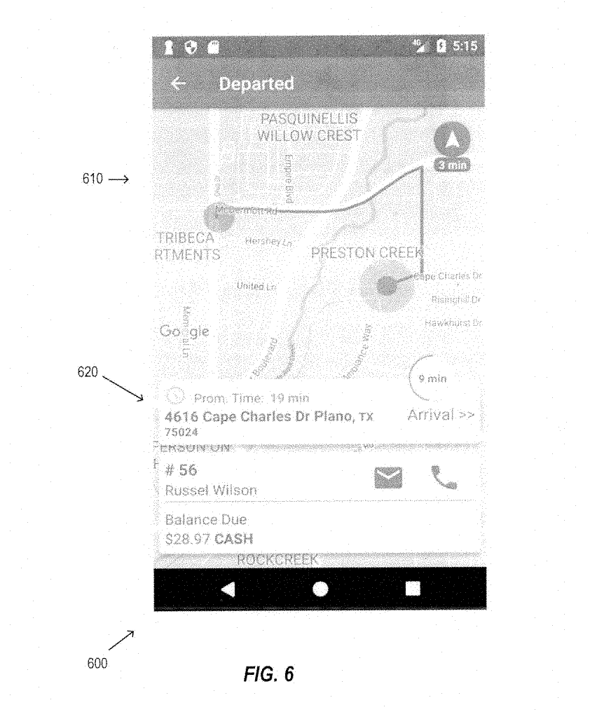

FIG. 6 is a diagram of an example GUI 600 for the delivery device 370 and illustrates a summary of a delivery order, according to an embodiment. The delivery device 370 provides the GUI 600 in a manner similar to the GUI 500. The delivery device 370 displays the summary of FIG. 6, for example, when an order of a dispatch assignment has been selected and/or when the delivery device 370 determines that it has departed the storefront 305. The GUI 600 includes a map 610 and an order summary 620. The map 610 is generally similar to the map 510 and shows a proposed route for delivering the selected order. The order summary 620 provides a summary of the selected order. In the embodiment shown in FIG. 6, the order summary 620 includes the delivery address, the promise time, the ETA to the delivery address, an order number, customer information and contact information, and payment information.

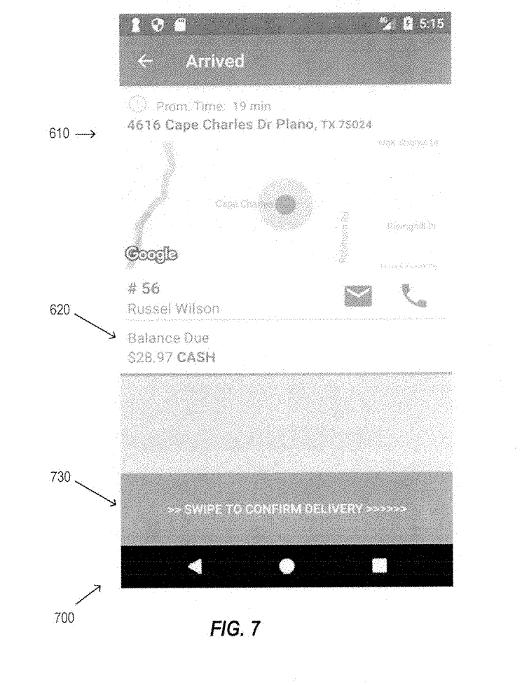

FIG. 7 is a diagram of an example GUI 700 for the delivery device 370 and illustrates a delivery order completion, according to an embodiment. The delivery device 370 provides the GUI 700 in a manner similar to the GUI 500. In some embodiments, the delivery device 370 automatically proceeds to the GUI 700 from the GUI 600, for example, when the delivery device 370 has arrived within a predetermined distance from the delivery address. In the embodiment shown in FIG. 7, the GUI 700 includes the map 610, the order summary 620, and a confirmation button 730. After delivery of the order and, if necessary, receipt of payment from the customer, the delivery driver taps (or swipes, gestures, etc.) the confirmation button 730 to confirm that the delivery has been completed. In response to the confirmation button 730, the delivery device 370 sends a confirmation to the dispatch device 330 and, if another order remains in the dispatch assignment, automatically advances to the GUI 600 for the next order.

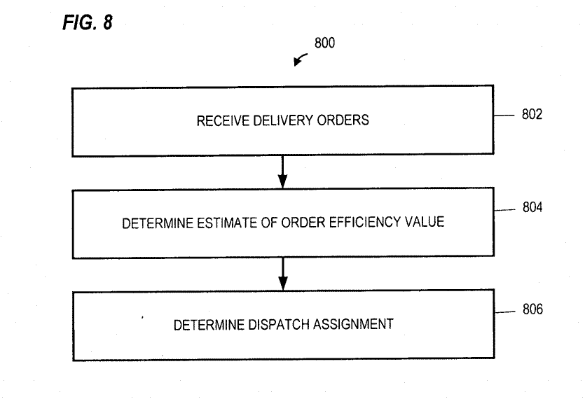

FIG. 8 is a flow diagram of an example method 800 of determining dispatch assignments of delivery orders by a point of sale device of a storefront, according to an embodiment. In some embodiments, the dispatch device 330 of FIG. 3 is configured to implement the method 800. The method 800 is described; however, in the context of the dispatch device 330 merely for explanatory purposes and, in other embodiments, the method 800 is implemented by another suitable device, for example, the client device 112 of FIG. 1. In an embodiment, for example, the server POS server 340 or the server 122 is configured to implement the method 800. In yet another embodiment, the dispatch device 330 and the POS server 340 are configured to perform one or more steps of the method 800, either separately, in cooperation with each other, or redundantly (e.g., the POS server 340 performs a step, with the dispatch device 330 performing the step in the event of a communication problem with the server 122).

At block 802, a POS device receives a plurality of delivery orders for a storefront, in an embodiment. The POS device corresponds to the dispatch device 330 of the storefront 305 and the plurality of delivery orders correspond to orders in the order listing 410, for example.

At block 804, the POS device determines an estimate of an order efficiency value for the storefront based on the plurality of delivery orders and a delivery employee pool corresponding to the storefront (e.g., the delivery employee pool 350), in an embodiment. The order efficiency value corresponds to an efficiency of the storefront in receiving, handling, and delivering delivery orders. In various embodiments, the order efficiency value is “forward-looking” in that it corresponds to handling orders that have not yet been delivered. For example, the order efficiency value indicates a percentage of delivery orders that are likely to be delivered by their respective promise times. By determining an estimate of the order efficiency value, the POS device provides an estimate of customer satisfaction for future delivery orders, and thus an action can be taken to prevent a drop in customer satisfaction. In various embodiments or scenarios, the action to prevent the drop in customer satisfaction is performed by the order expediter or automatically by the dispatch device 330.

At block 806, the POS device automatically determines a dispatch assignment (or a dispatch assignment proposal) of one or more delivery orders for the storefront to one of i) an employee of the delivery employee pool, or ii) a contractor of an independent contractor pool, based on whether the order efficiency value meets a predetermined service threshold, in an embodiment. The employees of the delivery employee pool are generally more cost-efficient for handling a delivery order than an independent contractor, and thus the storefront 305 has improved profitability when employees are used instead of independent contractors. However, in some scenarios, providing a dispatch assignment to a contractor provides a benefit of improved customer satisfaction, for example, to prevent a customer from receiving a delivery order after the promise time. In other scenarios, providing dispatch assignments to contractors increases an overall number of order handlers, which can improve the promise time of new orders and help to retain future orders. For example, a customer is more likely to purchase from a storefront when the promise time is typically 20 minutes than when the promise time is 50 minutes. Moreover, a customer is more likely to purchase from the storefront when the actual delivery time is within five minutes of the promise time than when the actual delivery time is 20 minutes after the promise time.

The POS device reduces the likelihood of increased delivery costs associated with contractors by utilizing the predetermined service threshold. For example, the POS device determines dispatch assignments for employees of the delivery employee pool unless the order efficiency value does not meet the predetermined service threshold. In an embodiment, for example, the order efficiency value is a ratio of a number of orders in the plurality of orders to a number of employees in the delivery employee pool (e.g., 24 orders divided over 6 employees, or 4) and the predetermined service threshold is 8. In this example, when the number of orders increases to 48 and the threshold is met (48 orders divided over 6 employees), the POS device automatically determines a dispatch assignment of delivery orders to an independent contractor.

In another embodiment, the order efficiency value is a promise time or an average of promise times for multiple orders. For example, where the promise time meets a threshold of 40 minutes, the POS device automatically determines a dispatch assignment of delivery orders to an independent contractor.

In some embodiments, the POS device automatically calls up employees when the threshold is met. For example, the POS device sends a request to other employees who are not currently working, as discussed above with respect to FIG. 4. In an embodiment, the POS device sends the request to employees of other storefronts (e.g., other storefronts of a same franchise). In yet another embodiment, the POS device sends the request to a POS device of the other storefront (e.g., the dispatch device 330 of the other storefront), which then prompts the order expediter of the other storefront to accept or decline the request.

The dispatch device 330 determines and displays the order efficiency value on the GUI 400, in some embodiments. For example, the dispatch device 330 displays the promise time for a prospective delivery order (e.g., an order that is currently being taken by the ordering device 310), which allows the order expediter to have advance notice of when a backlog of undelivered orders is developing. In an embodiment, the dispatch device 330 communicates with the ordering device 310 and/or the order display device 320 and estimates the order efficiency value based on the preparation status of the delivery orders. For example, if twenty new orders are entered within a short period of time, the dispatch device 330 updates the estimate of the order efficiency value when the new orders have been received and thus before they have been prepared and baked, as opposed to after the orders are ready for delivery. In this way, the order expediter (or the dispatch device 330) has more time to call up employees (and for the employees to become available for deliveries) before the orders are ready for delivery.

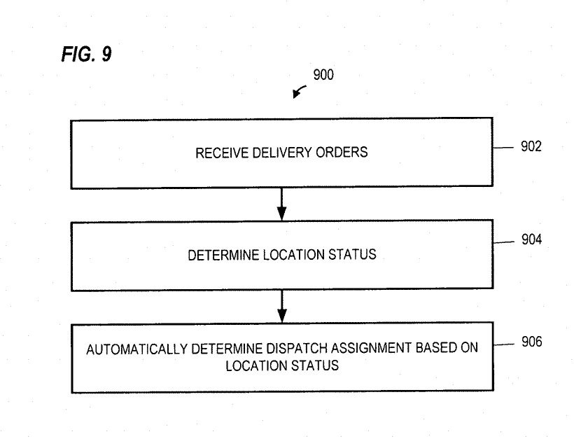

FIG. 9 is a flow diagram of an example method 900 of grouping delivery orders into a dispatch assignment by a POS device of a storefront, according to an embodiment. In some embodiments, the dispatch device 330 of FIG. 3 is configured to implement the method 900. The method 900 is described; however, in the context of the dispatch device 330 merely for explanatory purposes and, in other embodiments, the method 900 is implemented by another suitable device, for example, the client device 112 of FIG. 1. In an embodiment, for example, the server POS server 340 or the server 122 is configured to implement the method 900. In yet another embodiment, the dispatch device 330 and the POS server 340 are configured to perform one or more steps of the method 900, either separately, in cooperation with each other, or redundantly (e.g., the POS server 340 performs a step, with the dispatch device 330 performing the step in the event of a communication problem with the server 122).

At block 902, a POS device receives a plurality of delivery orders for a storefront, in an embodiment. The POS device corresponds to the dispatch device 330 of the storefront 305 and the plurality of delivery orders correspond to orders in the order listing 410, for example.

At block 904, the POS device determines respective location statuses of a plurality of delivery order handlers, where at least one of the plurality of order handlers is currently unavailable to handle deliveries and has an estimated time of availability for handling deliveries, in an embodiment. In other words, at least one order handler has not yet arrived for work, is currently delivering another order, is currently on route to the storefront 305 after delivering another order, etc. In an embodiment, the dispatch device 330 stores an availability ETA for each of the plurality of order handlers and updates the availability ETA based on information received from the order handler, for example, from a corresponding delivery device 370 of each order handler, from a processor of an autonomous vehicle, etc. In an embodiment, the delivery order handlers include one or more of: i) employees of the delivery driver pool 350, ii) contractors of the independent contractor pool 360, iii) self-driving vehicles configured for performing deliveries, and/or iv) autonomous drones configured for performing deliveries.

At block 906, the POS device automatically determines a dispatch assignment of one or more delivery orders of the plurality of delivery orders to a selected delivery order handler of the plurality of delivery order handlers based on the respective location statuses, in an embodiment. As one example, the POS device determines a dispatch assignment by selecting a first available order handler and one or more “oldest” orders of the plurality of delivery orders (e.g., orders that are ready for delivery and have been waiting the longest time). As another example, the POS device selects a first available order handler and two or more orders that can be delivered by a same order handler within their respective promise times. In some embodiments, the POS device determines a dispatch assignment based on potential routes between the storefront 305 and/or various delivery addresses of the plurality of delivery orders, traffic conditions along the potential routes, and an estimate of a transaction delay for the delivery orders. For example, the POS device determines one, two, or three or more potential routes from the storefront 305 to the delivery addresses of each of the plurality of orders.

Block 906 is performed by the dispatch device 330, the POS server 340, or a combination thereof, in various embodiments. As one example, the dispatch device 330 receives the location statuses from dispatch devices 370 and provides the location statuses to the POS server 340. In this example, the POS server 340 may have more processing power than the dispatch device 330 and thus determine the dispatch assignment more quickly and/or more optimally (e.g., by considering more inputs, routing options, etc.). In some scenarios, POS server 340 performs the determination of the dispatch assignment by default, but the dispatch device 330 performs the determination when the POS server 340 is unavailable, for example, when a communication link to the POS server 340 is down, when a timeout has expired, etc.

In some embodiments, the POS device determines dispatch assignments preemptively. In other words, the POS device determines a dispatch assignment that includes one or more orders that are not yet ready for delivery, and thus effectively “plans ahead” for potential dispatch assignments. As an example, the POS device determines dispatch assignments based on the status of a delivery order that is currently in the oven (or otherwise in preparation) and thus it is more likely that a delivery driver is ready to deliver the order when it becomes ready for delivery. In an embodiment, the POS device updates the order efficiency value based on the preemptive dispatch assignments, and thus the order expediter receives advance notice of when a potential backlog of undelivered orders is developing.

In some embodiments, the dispatch device 330 communicates with the ordering device 310 and/or the order display device 320 to determine the dispatch assignment. For example, the dispatch device 330 receives updates from the ordering device 310 when an order is created, receives updates from the order display device 320 when an order has been prepared, placed in the oven, finished baking, etc. Other suitable updates for changes in status of the order will be apparent to those skilled in the art. The dispatch device 330 utilizes the updates from the ordering device 310 and the kitchen device 32 to perform the preemptive dispatch assignments. In some scenarios, the receipt of an update is a trigger for the dispatch device 330 to update previously determined dispatch assignments. In other scenarios, the dispatch device 330 updates the previously determined dispatch assignments based on other conditions, such as timer expirations, available processing power, available bandwidth to the POS server 340, availability of the POS server 340 to perform an update, or other suitable conditions.

The dispatch assignments can be optimized by the dispatch device 330 (or POS server 340) based on various conditions, for example, route optimization for travel times of the delivery drivers, maximizing “freshness” of delivery orders by minimizing the time between when an order is ready for delivery and actually delivered to the customer, maximizing time spent “out of the store” by delivery drivers (e.g., reduce their waiting time at the storefront 305). In some embodiments, the dispatch device 330 communicates with the order display device 320 and/or ordering device 310 to cause a delay in the preparation of an order. As an example, if a next available delivery driver will return to the storefront 305 in fifteen minutes and the next delivery order will take thirteen minutes to be prepared (e.g., for toppings to be added to a pizza, bake time, cutting and boxing of the pizza), then the dispatch device 330 sends a message to the order display device 320 to cause a delay of two minutes in the preparation of the order. In the case of a pizza, an order is preferably delayed before the pizza has been prepared for the oven (e.g., before toppings are added) so that ingredients stay fresh. In some scenarios, the pizza has been prepared for the oven but is not placed into the oven until a suitable time as indicated by the message from the dispatch device 330. In an embodiment, the order display device 320 provides a user interface to order packers or kitchen staff which indicates when an order should be handled, which orders should be handled before other orders, etc.

The dispatch device 330 determines dispatch assignments for contractors differently from dispatch assignments for employees, in some embodiments. For example, the dispatch device 330 selects only prepaid delivery orders to be assigned to contractors. In this way, the contractors are less likely to be required to handle cash and to make an extra trip back to the storefront 305 to return the cash. In other examples, the dispatch device 330 selects orders that will be paid with a credit card, debit card, or gift card upon delivery. In an embodiment, the dispatch device 330 maintains a balance of an amount to be paid to a contractor and allows the contractor to deliver pay-on-delivery orders with values up to the balance. In other words, if a contractor is owed $40 for past deliveries, the contractor can receive up to $40 worth of deliveries for which payment (e.g., cash) could be accepted from the customer and then kept by the contractor as payment. In other embodiments, the dispatch device 330 initiates an electronic payment to the contractor upon completion of a dispatch assignment.

In an embodiment, the dispatch device 330 preferentially selects employees over contractors for new customers. In one scenario, a new customer is more likely to see an employee delivery driver who may be wearing clothing, trade dress, or have a car topper with a logo associated with the storefront 305. In another scenario, potential customers in a desirable neighborhood for sales may be more likely to see the car topper and be encouraged to place a new order.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable memory such as on a magnetic disk, an optical disk, or other storage medium, in a RAM or ROM or flash memory, processor, hard disk drive, optical disk drive, tape drive, etc. The software or firmware instructions may include machine readable instructions that, when executed by one or more processors, cause the one or more processors to perform various acts.

When implemented in hardware, the hardware may comprise one or more of discrete components, an integrated circuit, an application-specific integrated circuit (ASIC), a programmable logic device (PLD), etc.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A method for determining dispatch assignments of delivery orders by a point of sale (POS) device of a storefront, the method comprising:
receiving, at the POS device, a plurality of delivery orders for the storefront;
determining, by the POS device, an estimate of an order efficiency value for the storefront based on the plurality of delivery orders and a delivery employee pool corresponding to the storefront; and
automatically determining, by the POS device, a dispatch assignment of one or more delivery orders for the storefront to one of i) an employee of the delivery employee pool, or ii) a contractor of an independent contractor pool, based on whether the order efficiency value meets a predetermined service threshold.

2. The method of claim 1, further comprising:
determining, by the POS device, a promise time of a prospective delivery order for the storefront based on an estimated delivery time for the prospective delivery order using the independent contractor pool; and
displaying, by the POS device, a user interface that indicates the promise time.

3. The method of claim 1, further comprising:
assigning, by the POS device, the one or more delivery orders of the dispatch assignment to the contractor of the independent contractor pool; and
initiating, by the POS device, an electronic payment to the contractor of the independent contractor pool upon completion of the one or more delivery orders.

4. The method of claim 3, wherein automatically determining the dispatch assignment of the one or more delivery orders comprises selecting only prepaid orders for the storefront as the one or more delivery orders assigned to the contractor of the independent contractor pool.

5. The method of claim 3, wherein assigning the one or more delivery orders of the dispatch assignment comprises:
providing a dispatch assignment proposal to the independent contractor pool for acceptance, wherein the dispatch assignment proposal indicates the dispatch assignment;
receiving an acceptance of the dispatch assignment proposal from the contractor of the independent contractor pool.

6. The method of claim 5, wherein providing the dispatch assignment proposal comprises:
transmitting the dispatch assignment proposal to mobile communication devices corresponding to contractors of the independent contractor pool.

7. The method of claim 3, wherein assigning the one or more delivery orders of the dispatch assignment comprises:
providing a dispatch assignment proposal to only the contractor of the independent contractor pool for acceptance, wherein the dispatch assignment proposal indicates the dispatch assignment;
receiving an acceptance of the dispatch assignment proposal from the contractor of the independent contractor pool.

8. The method of claim 1, wherein the order efficiency threshold corresponds to a ratio of a number of orders in the plurality of orders to a number of employees in the delivery employee pool.

9. A method for grouping delivery orders into a dispatch assignment by a point of sale (POS) device of a storefront, the method comprising:
receiving, at the POS device, a plurality of delivery orders for the storefront;
determining, by the POS device, respective location statuses of a plurality of delivery order handlers, wherein at least one of the plurality of order handlers is currently unavailable to handle deliveries and has an estimated time of availability for handling deliveries;
automatically determining, by the POS device, a dispatch assignment of one or more delivery orders of the plurality of delivery orders to a selected delivery order handler of the plurality of delivery order handlers based on the respective location statuses.

10. The method of claim 9, wherein the selected delivery order handler is currently unavailable for delivery when the dispatch assignment is determined.

11. The method of claim 10, wherein the respective location statuses include an estimated time of availability of the corresponding delivery order handler.

12. The method of claim 9, wherein:
the plurality of delivery orders includes at least one delivery order that is currently unavailable for delivery with a corresponding estimated time of availability;
automatically determining the dispatch assignment comprises automatically determining the dispatch assignment based on the respective location statuses and the estimated time of availability;
the dispatch assignment includes a selected delivery order of the at least one delivery order that is currently unavailable for delivery.

13. The method of claim 12, further comprising causing a delay to a preparation start time of the selected delivery order.

14. The method of claim 9, wherein:
the dispatch assignment is a dispatch assignment proposal;
the method further comprises:
displaying, by the POS device, a user interface that indicates the dispatch assignment proposal;
receiving, by the POS device and from a user, a user input that confirms the dispatch assignment proposal;
transmitting, by the POS device, the dispatch assignment to a mobile communication device corresponding to the selected delivery order handler.
